(19) United States
(12) Patent Application Publication
(10) Pub. No.: US 2011/0053757 A1
(43) Pub. Date: Mar. 3, 2011

(54) Methods for Making Aluminum Titanate Bodies and Minimizing Shrinkage Variability Thereof

(76) Inventors: Stephen John Caffery, Rochester, NY (US); Anthony Joseph Cecce, Elmira, NY (US); Sandra Lee Gray, Horseheads, NY (US); Daniel Edward McCauley, Watkins Glen, NY (US); Patrick David Tepesch, Corning, NY (US); Christopher John Warren, Waverly, NY (US)

(21) Appl. No.: 12/550,011

(22) Filed: Aug. 28, 2009

(51) Int. Cl. C04B 35/478; G06G 7/48

(52) U.S. Cl. 501/127; 703/6

(57) ABSTRACT

The disclosure relates to methods for making aluminum titanate-containing ceramic bodies, and methods for predicting shrinkage and minimizing shrinkage variability of said bodies from target size.

### FIELD OF THE DISCLOSURE

The disclosure relates to methods for making aluminum titanate-containing ceramic bodies, and methods for predicting shrinkage and minimizing shrinkage variability of said bodies from a target size.

### BACKGROUND

Aluminum titanate-containing ceramic bodies are viable for use in the sever conditions of exhaust gas environments, including, for example as catalytic converters and as diesel particulate filters. Among the many pollutants in the exhaust gases filtered in these applications are, for example, hydrocarbons and oxygen-containing compounds, the latter including, for example, nitrogen oxides (NOx) and carbon monoxide (CO), and carbon based soot and particulate matter. Aluminum titanate-containing ceramic bodies exhibit high thermal shock resistance, enabling them to endure the wide temperature variations encountered in their application, and they also exhibit other advantageous properties for diesel particulate filter applications, such as, for example, high porosity, low coefficient of thermal expansion (CTE), resistance to ash reaction, and modulus of rupture (MOR) adequate for the intended application.

As such, there exists a need for the ability to produce extrude-to-shape aluminum titanate-containing ceramic bodies with precision, for example to predict shrinkage when going from a green to fired body. Moreover, there is a need for a method to minimize shrinkage variability of such aluminum titanate-containing ceramic bodies from the targeted size.

### SUMMARY

In accordance with the detailed description and various exemplary embodiments described herein, the disclosure relates to methods of making aluminum titanate-containing ceramic bodies comprising forming batch mixtures comprising at least one alumina source, forming green bodies from said batch mixtures; and firing said green bodies to form aluminum titanate-containing ceramic bodies. In various embodiments, the method further comprises adjusting process parameters if data from the particle size distribution (“PSD”) of the at least one alumina source indicates a predicted shrinkage of the aluminum titanate-containing ceramic body of ±0.8% or more from the target size.

The disclosure also relates to methods for predicting shrinkage of aluminum titanate-containing ceramic bodies formed from batch mixtures, wherein said batch mixtures comprise at least one alumina source, and wherein said method comprises (1) obtaining PSD reference data for reference alumina sources and the at least one alumina source; (2) applying an algorithm to the PSD reference data to determine at least one reference vector amount; (3) creating a linear model to predict shrinkage using the at least one reference vector amount; (4) applying the algorithm to the at least one alumina source PSD data to determine at least one batch vector amount; and (5) applying the linear model to the at least one batch vector amount to predict shrinkage of the aluminum titanate-containing ceramic bodies.

The disclosure also relates to methods of minimizing shrinkage variability of aluminum titanate-containing ceramic bodies formed from batch mixtures, wherein said batch mixtures comprise at least one alumina source, and wherein said method comprises (1) determining the predicted shrinkage of the aluminum titanate-containing ceramic body; and (2) adjusting process parameters, if the predicted shrinkage of the aluminum titanate-containing ceramic body is ±0.8% or more from the target size.

### BRIEF DESCRIPTION OF THE DRAWING

The accompanying drawing is included to provide a further understanding of the invention, and is incorporated in and constitutes a part of this specification. The drawing is not intended to be restrictive of the invention as claimed, but rather is provided to illustrate exemplary embodiments of the invention and, together with the description, serves to explain the principles of the invention.

FIG. 1 depicts representative graphs of PSD data from reference alumina sources.

### DETAILED DESCRIPTION

It is to be understood that both the foregoing general description and the following detailed description are exemplary and explanatory only and are not restrictive of the invention, as claimed. Other embodiments will be apparent to those skilled in the art from consideration of the specification and practice of the embodiments disclosed herein.

The disclosure relates to methods for making aluminum titanate-containing ceramic bodies from batch mixtures, wherein said batch mixtures comprise at least one alumina source, and methods for predicting shrinkage and minimizing shrinkage variability of said bodies from a target size.

As used herein, the term “shrinkage,” and variations thereof, is intended to mean the deviations in size that result when a shaped green body is fired to make an aluminum titanate-containing ceramic body. Thus, shrinkage is intended to include an increase and/or decrease in the size of the body. It is within the ability of one skilled in the art to measure the size and deviations in size or shrinkage of a shaped body. In various embodiments, for example, the size and deviations in size of a shaped body may be measured using a laser gauge technique.

As used herein, the term “minimizing shrinkage variability” of an aluminum titanate-containing ceramic body, and variations thereof, is intended to mean obtaining an aluminum titanate-containing ceramic body from a shaped green body, wherein the difference in the deviations in size observed for the ceramic body compared to the predicted deviations in size or targeted size are insignificant for the product and/or its applications. In various embodiments of the present disclosure, shrinkage variability is minimized when the deviations in size observed for the ceramic body vary by ±0.8% or less from the predicted deviations in size or target size.

As used herein, the term “batch mixture,” and variations thereof, is intended to mean a substantially homogeneous mixture comprising inorganic materials and optionally pore-forming materials. In various exemplary embodiments of the present disclosure, the batch mixture may comprise at least one alumina source.

Sources of alumina include, but are not limited to, powders that when heated to a sufficiently high temperature in the absence of other raw materials, will yield substantially pure aluminum oxide. Examples of such alumina sources include alpha-alumina, a transition alumina such as gamma-alumina, calcined alumina, or rho-alumina, hydrated alumina, gibbsite, corundum (Al₂O₃), boehmite (AlO(OH)), pseudoboehmite, aluminum hydroxide (Al(OH)₃), aluminum oxyhydroxide, and mixtures thereof. In at least one embodiment, the at least one alumina source is calcined alumina.

In various exemplary embodiments of the disclosure, the at least one alumina source may be chosen from, but is not limited to, commercially available calcined alumina products, such as that sold under the designation A10-325 by Almatis, Inc. of Leetsdale, Pa., and those sold under the trade name Microgrit WCA20, WCA25, WCA30, WCA40, WCA45, and WCA50 by Micro Abrasives Corp. of Westfield, Mass.

In various exemplary embodiments, the at least one alumina source may comprise at least 40 wt %, at least 45 wt %, or at least 50 wt % of the inorganic materials comprising the batch mixture, such as, for example, 47 wt % of the inorganic materials.

In various embodiments, the at least one alumina source may be selected such that it has a PSD indicative of a predicted shrinkage for the aluminum titanate-containing ceramic body of ±0.8% or less from the target size, for example, ±0.5% or less, or ±0.3% or less from the target size.

The predicted shrinkage of an aluminum titanate-containing ceramic body may be determined by: (1) obtaining PSD reference data for reference alumina sources and the at least one alumina source; (2) applying an algorithm to the PSD reference data to determine at least one reference vector amount; (3) creating a linear model to predict shrinkage using the at least one reference vector amount; (4) applying the algorithm to the at least one alumina source PSD data to determine at least one batch vector amount; and (5) applying the linear model to the at least one batch vector amount to predict shrinkage of the aluminum titanate-containing ceramic body.

As used herein, the phrase “reference alumina sources,” and variations thereof, refers to at least two different batches or lots of alumina material suitable for use in making aluminum titanate-containing ceramic bodies. For example, the reference alumina sources may comprise at least 10, at least 50, or at least 100 different batches or lots of alumina material. In further embodiments of the disclosure, the reference alumina sources may be of the same material designation or grade. By way of example only, in at least one embodiment, the reference alumina sources may comprise at least 100 different batches or lots of alumina material of the same grade. In various embodiments, the reference alumina sources may be chosen from commercially available products, such as calcined alumina sources sold under the designation A10-325 by Almatis, Inc. of Leetsdale, Pa., and those sold under the trade name and designation Microgrit WCA20, WCA25, WCA30, WCA40, WCA45, and WCA50 by Micro Abrasives Corp. of Westfield, Mass. In various embodiments, the reference alumina sources do not include the lot selected as the at least one alumina source of the batch mixture.

The PSD reference data referred to herein are obtained from the PSD of each of the reference alumina sources. It is within the ability of one skilled in the art to obtain PSD of the various reference alumina sources and the data therefrom. For example, in various embodiments, PSD may be obtained by laser scattering techniques.

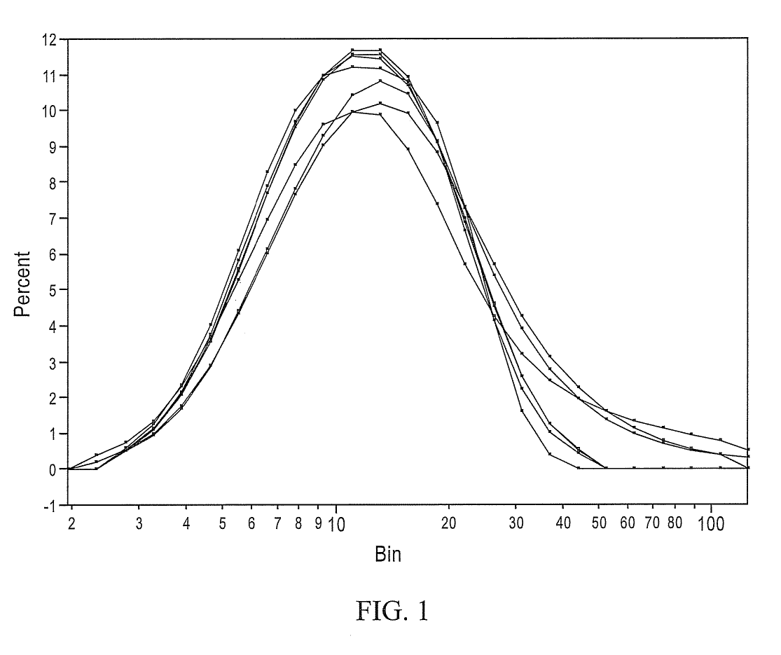

Although the PSD reference data may be obtained from reference alumina sources of the same designation or grade, the PSD and corresponding data may vary from one reference source to another. For example, FIG. 1 graphically depicts representative PSDs of reference alumina sources of the same grade, with each curve corresponding to a different source. The x-axis (bins) corresponds to specific particle size intervals, and the y-axis (percent) corresponds to the percentages of alumina particles that fall within a given bin. As can be seen in FIG. 1, even though the alumina sources represented by the curves are of the same grade, the curves may vary throughout their length. The algorithm of the disclosed methods comprises a multivariate statistical analysis technique that can quantify the variability of the PSD reference data. In the disclosed methods, the variability is then linked in a predictive way to shrinkage of an aluminum titanate-containing ceramic body made from a given alumina source.

It is often the case that intuitively chosen predictor variables are highly correlated with each other. Where correlation describes the degree of relationship of two variables on a scale from −1 to 1, 0 means that two variables are uncorrelated with each other, and as the correlation moves away from 0 toward either −1 or 1, it is said that the variables are more correlated with each other. It is desired to have predictor variables that are uncorrelated with each other.

In various embodiments of the disclosure, principal component analysis (“PCA”) is used to derive uncorrelated variables from PSD reference data. PCA is a linear transformation of the original variables, which are the PSD data of alumina reference sources, to produce new predictor variables that are uncorrelated with each other. In systems with high redundancy or correlation among the original variables, such as in the case of the PSD reference data, often only a small number of principal components are necessary to represent the variability in the un-transformed data. For example, a system with 20 dimensions may need only 3 or 4 principal components to capture most of the variability in the 20 dimensions; hence, the original data has been reduced to 3 or 4 uncorrelated variables. These new variables may be useful as predictor variables.

The details of the mathematics of extracting the components identified above are not provided herein because PCA is generally known and is present in most statistical analysis packages, and is within the ability of one skilled in the art to access and utilize. For example, PCA techniques are provided by Minitab Inc. in its Minitab software and by SAS Institute Inc. in its JMP software, both of which may be utilized in the disclosed methods. Moreover, the principals of PCA are described in texts such as J. Edward Jackson, “A User's Guide to Principal Components,” (John Wiley & Sons 1991).

The Principal Components derived from the analysis order the variability in the original PSD reference data from highest to lowest. In various embodiments, the at least one reference vector amount of the disclosed method may be selected from the Principal Components. For example, the at least one vector amount may be the component with the highest variability. In further embodiments, at least two reference vector amounts may be selected from the Principal Components, for example, the two components with the highest variabilities. In further embodiments, at least three reference vector amounts may be selected from the Principal Components, for example, the three components with the highest variabilities. In further embodiments, at least four reference vector amounts may be selected from the Principal Components, for example, the four components with the highest variabilities.

In various embodiments of the disclosure, a predictive linear model may be formed using the at least one reference vector amount to predict shrinkage.

For example, Multiple Linear Regression (“MLR”) may be used to form the predictive model. The details of the mathematics of MLR are not provided herein because MLR is generally a part of most statistical analysis packages and statistical texts dealing with regression. Thus, it is within the ability of one skilled in the art to access and utilize.

In various embodiments, the resulting linear model may then be used to predict shrinkage of aluminum titanate-containing ceramic bodies as a function of the at least one alumina source, specifically its PSD. First, the algorithm described above may be applied to the at least one alumina source PSD data to determine at least one batch vector amount. As explained above, in various embodiments, PCA may be used to derive uncorrelated variables from PSD data, and the at least one batch vector amount may be selected from the resulting components in the manner described above as well. Further, the linear model formed from the alumina reference source data to predict shrinkage is applied to the at least one batch vector amount to predict shrinkage of the resulting aluminum titanate-containing ceramic body.

In other embodiments of the disclosure, the at least one vector amount may be useful as a predictor variable of other ceramic body properties, such as, for example, median pore diameter and modulus of rupture (MOR). A predictive linear model relating to another property may be formed using the at least one reference vector amount, and the resulting model may be used to predict that property for ceramic bodies based on the at least one alumina source.

In various embodiments, the disclosure further relates to methods of making aluminum titanate-containing ceramic bodies comprising forming batch mixtures comprising at least one alumina source, as described herein, forming green bodies from said batch mixtures; and firing said green bodies to form aluminum titanate-containing ceramic bodies.

In further exemplary embodiments, the batch mixture may further comprise at least one source of titania. Sources of titania which may be present in the batch mixture include, but are not limited to, rutile, anatase, and amorphous titania.

In various exemplary embodiments, the at least one titania source may comprise at least 20 wt % of the inorganic materials comprising the batch mixture, for example at least 25 wt %, at least 30 wt %, or at least 35 wt % of the inorganic materials, such as 30 wt %.

In various embodiments of the disclosure, the batch mixture may further comprise other inorganic materials, referred to herein as at least one additional material. In at least one embodiment, the at least one additional material may be chosen from silica, oxides (e.g. lanthanum oxide), carbonates (e.g. calcium carbonate and strontium carbonate), nitrates, and hydroxides. In at least one embodiment, the at least one additional material may be chosen from the following oxides: yttrium oxide, magnesium oxide, barium oxide, sodium oxide, potassium oxide, lithium oxide, iron oxide, boric oxide, and phosphorous oxide. These oxides may be added as oxides, carbonates, nitrates, hydroxides, or multi-component compounds with one another or titanium dioxide, aluminum oxide, silicone dioxide, calcium oxide, strontium oxide, or lanthanum oxide.

In various embodiments of the disclosure, the batch mixture may further comprise at least one pore-forming material. As used herein, the term “pore-forming material,” and variations thereof, means organic materials selected from the group of: carbon (e.g., graphite, activated carbon, petroleum coke, and carbon black), starch (e.g., corn, barley, bean, potato, rice, tapioca, pea, sago palm, wheat, canna, and walnut shell flour), and polymers (e.g., polybutylene, polymethylpentene, polyethylene (preferably beads), polypropylene (preferably beads), polystyrene, polyamides (nylons), epoxies, ABS, Acrylics, and polyesters (PET)). In at least one embodiment, the at least one pore-forming material is a starch chosen from rice, corn, sago palm and potato. In at least one embodiment, the at least one pore-forming material is not graphite.

In various exemplary embodiments, the at least one pore-forming material may be present in any amount to achieve a desired result. For example, the at least one pore-forming material may comprise at least 1 wt % of the batch mixture, added as a super-addition (i.e., the inorganic materials comprise 100% of the batch mixture, such that the total batch mixture is 101%). For example, the at least one pore-forming material may comprise at least 5 wt %, at least 12.5 wt %, at least 15 wt %, at least 18 wt %, or at least 20 wt % of the batch mixture added as a super-addition.

The batch mixture may be made by any method known to those of skill in the art. By way of example, in at least one embodiment, the inorganic materials may be combined as powdered materials and intimately mixed to form a substantially homogeneous mixture. At least one pore-forming material may be added to form a batch mixture before or after the inorganic materials are intimately mixed. In that exemplary embodiment, the at least one pore-forming material and inorganic materials may then be intimately mixed to form a substantially homogeneous batch mixture. It is within the ability of one of skill in the art to determine the appropriate steps and conditions for combing the inorganic materials and at least one pore-forming material to achieve a substantially homogeneous batch mixture.

In additional exemplary embodiments, batch material may be mixed with any other known component useful for making batch material. For example, a binder, such as an organic binder, and/or a solvent may be added to the batch material to form a plasticized mixture. In such an embodiment, it is within the ability of one skilled in the art to select an appropriate binder. By way of example only, an organic binder may be chosen from cellulose-containing components, for example, (Hydroxypropyl) methylcellulose, methylcellulose derivatives, and combinations thereof, may be used.

It is also within the ability of one skilled in the art to select an appropriate solvent, if desired. In various exemplary embodiments, the solvent may be water, for example deionized water. It is also within the ability of one skilled in the art to select an appropriate oil for addition to the batch material, if desired.

The additional component, such as organic binder and/or solvent and/or oil, may be mixed with the batch material individually, in any order, or together to form a substantially homogeneous mixture. It is within the ability of one of skill in the art to determine the appropriate conditions for mixing the batch material with the organic binder and solvent to achieve a substantially homogeneous material. For example, the components may be mixed by a kneading process to form a substantially homogeneous mixture.

In various embodiments, the method further comprises forming green bodies from batch mixtures and firing said green bodies to form aluminum titanate-containing ceramic bodies.

The mixture may, in various embodiments, be formed into a green body and fired to form a ceramic body by any process known to those of skill in the art. By way of example, the mixture may be injection molded or extruded and optionally dried by conventional methods known to those of skill in the art to form a green body.

In various exemplary embodiments, the green body may then be fired to form an aluminum titanate-containing ceramic body. It is within the ability of one skilled in the art to determine the appropriate method and conditions for forming a ceramic body, such as, for example, firing conditions including equipment, temperature and duration, to achieve an aluminum titanate-containing ceramic body, depending in part upon the size and composition of the green body. Non-limiting examples of firing cycles for aluminum titanate-containing ceramic bodies can be found in International Publication No. WO 2006/130759, which is incorporated herein by reference. For example, the composition of the batch material may allow for shorter drying and firing times than used for conventional batch materials, and in a further embodiment, this may result in the ability to easily make large ceramic bodies as well.

The disclosure also relates to methods of predicting shrinkage of aluminum titanate-containing ceramic bodies formed from batch mixtures, wherein said batch mixtures comprise at least one alumina source, using the methods described herein to predict shrinkage.

The disclosure further relates to methods for minimizing shrinkage variability of aluminum titanate-containing ceramic bodies relative to target size using the methods described above to arrive at the predicted shrinkage and then adjusting the process parameters to achieve an aluminum titanate-containing ceramic body with shrinkage within the targeted range, such as, for example within ±0.8% or less of the target size.

As used herein, the term “process parameters,” and variations thereof, is intended to include any variable relating the method of making an aluminum titanate-containing ceramic body, including, for example, the amounts of the batch components, the size of the extruded green body, and the method and conditions for firing. It is within the ability of one skilled in the art to select and adjust the process parameters according to the desired result.

The disclosure also relates to methods for making other ceramic bodies comprising aluminum, and methods for predicting shrinkage and minimizing shrinkage variability of said bodies from target size. For examples, in various embodiments, the methods disclosed herein may also apply to silicon carbide-containing ceramic bodies and cordierite containing bodies, both of which may be formed from batch materials comprising at least one alumina as described herein and other batch components specific to the given type of ceramic body. In various embodiments and as described above, the algorithm of the disclosed methods comprises a multivariate statistical analysis technique that can quantify the variability of the PSD reference alumina source data. In various embodiments, the variability is then linked in a predictive way to shrinkage (or another property) of a ceramic body made from a given alumina source. The resulting model may be used to predict shrinkage (or another property) for ceramic bodies based on the at least one alumina source.

The disclosure also relates to methods for making other ceramic bodies and methods for predicting shrinkage and minimizing shrinkage variability of said bodies from target size. In various embodiments and as described above, the algorithm of the disclosed methods comprises a multivariate statistical analysis technique that can quantify the variability of the PSD data of a given batch material. In various embodiments, the variability is then linked in a predictive way to shrinkage (or another property) of a ceramic body made from a given batch material. The resulting model may be used to predict shrinkage (or another property) for ceramic bodies based on the given batch material.

Unless otherwise indicated, all numbers used in the specification and claims are to be understood as being modified in all instances by the term “about,” whether or not so stated. It should also be understood that the precise numerical values used in the specification and claims form additional embodiments of the invention. Efforts have been made to ensure the accuracy of the numerical values disclosed in the Examples. Any measured numerical value, however, can inherently contain certain errors resulting from the standard deviation found in its respective measuring technique.

As used herein the use of “the,” “a,” or “an” means “at least one,” and should not be limited to “only one” unless explicitly indicated to the contrary. Thus, for example, the use of “the batch mixture” or “batch mixture” is intended to mean at least one batch mixture.

Other embodiments of the invention will be apparent to those skilled in the art from consideration of the specification and practice of the invention disclosed herein. It is intended that the specification and examples be considered as exemplary only, with a true scope and spirit of the invention being indicated by the claims.

What is claimed is:

1. A method for predicting shrinkage of an aluminum titanate-containing ceramic body formed from a batch mixture, wherein said batch mixture comprises at least one alumina source, and wherein said method comprises:
(1) obtaining PSD reference data from reference alumina sources and the at least one alumina source;
(2) applying an algorithm to the PSD reference data to determine at least one reference vector amount;
(3) forming a linear model to predict shrinkage using the at least one reference vector amount;
(4) applying the algorithm to the at least one alumina source PSD data to determine at least one batch vector amount; and
(5) applying the linear model to the at least one batch vector amount to obtain the predicted shrinkage.

2. The method of claim 1, wherein the algorithm comprises a principal components analysis.

3. The method of claim 1, wherein the at least one reference vector amount comprises at least four reference vector amounts.

4. The method of claim 1, wherein the at least one batch vector amount comprises at least four batch vector amounts.

5. The method of claim 1, wherein the linear model is formed using multiple linear regression.

6. A method for minimizing shrinkage variability from target size of an aluminum titanate-containing ceramic body formed from a batch mixture, wherein said batch mixture comprises at least one alumina source, and wherein said method comprises:
(1) determining the predicted shrinkage of the aluminum titanate-containing ceramic body; and
(2) adjusting process parameters if the predicted shrinkage of the aluminum titanate-containing ceramic body is ±0.8% or more from the target size;
wherein the predicted shrinkage is determined by:
(A) obtaining PSD reference data from reference alumina sources and the at least one alumina source;
(B) applying an algorithm to the PSD reference data to determine at least one reference vector amount;
(C) forming a linear model to predict shrinkage using the at least one reference vector amount;
(D) applying the algorithm to the at least one alumina source PSD data to determine at least one batch vector amount; and
(E) applying the linear model to the at least one batch vector amount to obtain the predicted shrinkage.

7. The method of claim 6, wherein the algorithm comprises a principal components analysis.

8. The method of claim 6, wherein the at least one reference vector amount comprises at least four reference vector amounts.

9. The method of claim 6, wherein the at least one batch vector amount comprises at least four batch vector amounts.

10. The method of claim 6, wherein the linear model is formed using multiple linear regression.

11. The method of claim 6, wherein the process parameters are adjusted if the predicted shrinkage of the aluminum titanate-containing ceramic body is ±0.3% or more from the target size.

12. A method for making an aluminum titanate-containing ceramic body comprising:
forming a batch mixture comprising at least one alumina source,
forming a green body from said batch mixture; and
firing said green body to form an aluminum titanate-containing ceramic body;
wherein the process parameters are adjusted if the at least one alumina source PSD data indicates a predicted shrinkage for the aluminum titanate-containing ceramic body of ±0.8% or more from the target size;
wherein the predicted shrinkage is determined by:
(1) obtaining PSD reference data from reference alumina sources and the at least one alumina source;
(2) applying an algorithm to the PSD reference data to determine at least one reference vector amount;
(3) forming a linear model to predict shrinkage using the at least one reference vector amount;
(4) applying the algorithm to the at least one alumina source PSD data to determine at least one batch vector amount; and
(5) applying the linear model to the at least one batch vector amount to obtain the predicted shrinkage.

13. The method of claim 12, wherein the algorithm comprises a principal components analysis.

14. The method of claim 12, wherein the at least one reference vector amount comprises at least four reference vector amounts.

15. The method of claim 12, wherein the at least one batch vector amount comprises at least four batch vector amounts.

16. The method of claim 12, wherein the linear model is formed using multiple linear regression.

17. The method of claim 12, wherein the process parameters are adjusted if the predicted shrinkage of the aluminum titanate-containing ceramic body is ±0.3% or more from the target size.
